(19) United States
(12) Patent Application Publication
(10) Pub. No.: US 2019/0362354 A1
(43) Pub. Date: Nov. 28, 2019

(54) REAL-TIME UPDATING OF PREDICTIVE ANALYTICS ENGINE

(71) Applicant: EMC IP Holding Company LLC, Hopkinton, MA (US)

(72) Inventors: Alex Zaslavsky, Petah Tiqwa (IL); Marcelo Blatt, Modiin (IL); Alon Kaufman, Herut (IL); Yael Villa, Tel Aviv (IL)

(21) Appl. No.: 16/535,638

(22) Filed: Aug. 8, 2019

Related U.S. Application Data
(63) Continuation of application No. 14/040,307, filed on Sep. 27, 2013.

(51) Int. Cl. G06Q 20/40

(52) U.S. Cl. CPC G06Q 20/4016

(57) ABSTRACT

An improved risk analysis method addresses problems in the prior art methods of risk value calculation accuracy, inability to tailor the risk calculation to specific clients, and the inability to adjust the calculation method to account for rapid changes in fraud methodology. The improved method allows individual clients to use their knowledge of which risk parameters are most important to their particular business and automatically translates a statement of a new parameter sent by the client to the risk analysis calculation engine into the same type of statistical relationships used to evaluate risk using standard parameters.

### CROSS-REFERENCE TO RELATED APPLICATIONS

This application is a continuation of copending U.S. patent application Ser. No. 14/040,307, filed Sep. 27, 2013, the contents and teachings of which are incorporated by reference herein in their entirety.

### BACKGROUND

Businesses employ risk management tools such as adaptive authentication to reduce the level of risk associated transactions. Such tools provide quantitative risk analysis on a real time basis to business clients, allowing each individual transaction to be evaluated for risk prior to completion. For example, adaptive authentication uses historical transaction data to build a behavioral profile that is used in assigning a level of risk to a transaction request.

The above-described tools typically compute a risk score that depends on any number of factors related to personal and transaction data. To effect such a computation risk analytic engines, which are computers, configured to generate such risk scores upon receiving transaction parameter value, and use the computed risk score to predict the chances of a specific transaction being fraudulent.

Risk scores are computed according to an established risk model. Such risk models weight various risk factors according to the sensitivity of those factors to a likelihood of fraud using statistical and machine learning supervised techniques such as Bayesian networks. A conventional risk model may be updated periodically to account for changes in existing fraud methods, and the risk parameters, or the coefficients of the parameters may be changed to better match the calculated risk values to the actual observed risk, for example, twice a year.

For example, suppose that a credit card purchase request is sent by a client to a central risk analysis center for a calculation of risk of the transaction based upon an established risk model using a computer evaluating potential risk based on common risk parameters and coefficients. The establish risk calculation methods use which provides a risk score that is sent to the client in order to decide whether to permit the proposed transaction to be completed.

### SUMMARY

There are deficiencies, however, with the above-described conventional risk models. For example, a fraud analyst may discover a correlation between a new transaction parameter and a level of fraud. If that new transaction parameter is not part of the risk model, then the risk score calculation will not reflect this correlation and may not reflect reality on the ground. Also, it is difficult to make such new parameters part of the risk model because the risk model is centralized.

Moreover, the analyst may need to re-evaluate coefficients of the established parameters with respect to the transaction values periodically. For example, fraudsters may realize that businesses are aware of the increased likelihood of fraud with newly opened accounts having large monetary transaction values, and may switch their tactics to using newly opened accounts for numerous small transactions in various locations and at unusual times of the day. In such an example, the risk parameter coefficient for the age of the account should be reduced, while the risk parameter coefficient for multiple small transactions on a specific account within a given time period should be increased, in order to maintain the risk calculation accuracy as compared to actual fraud risk percentages.

Other examples of such parameters may include the knowledge that newly opened credit card accounts, for example within less than a month of account activation, have an increased likelihood of being involved in fraudulent transactions as compared to credit card accounts having a longer time since activation. Thus, the parameter in this example might be the age of an account, the coefficient of the parameter may be the known present rate of fraud versus account age, and the client provided transaction value is the age of the specific account currently in question. The time since activation parameters may be used in conjunction with other risk parameters such as an increased risk of fraud with unusually large value transactions, or with a parameter describing how risk may increase if the transaction occurs at certain known geographical locations. With these pieces of information, a risk score may be assigned to each proposed individual transaction in real time.

Another potential problem with existing risk engine methods may include that the established parameter set may not be applicable to different types of businesses. For example, businesses whose customers are heavily weighted towards teenagers, for example, a skateboard shop, are not likely to have many customers with accounts of long standing. In such a situation the standard coefficients for the age of account parameter may greatly over rate the actual risk of fraud. A different parameter than those contained in the set of established parameters may be needed to accurately predict the risk score for such a transaction, for example, the average grade point average in the previous school year may be a more appropriate parameter for a skateboard business.

The risk engine and the common parameters and coefficients used in the risk calculations are generally maintained in a centralized computer facility that manages risk calculations for hundreds of different clients. The risk analytics engines are programmed to determine risk based upon a risk model that needs to be updated when an analysis of the accuracy of the risk calculation is found to have decreased. Current approaches to risk analytic engines do not allow an updating of the calculation model in real time or in response to the special requirements of businesses having different client bases than the average business. Current risk models do not include special parameters optimized for individual business situations, and do not allow the businesses own risk analyst to include special parameters for their own use in the calculation. The current approaches are not easily updatable, customizable, or flexible.

In contrast with the above-mentioned conventional risk models that are difficult to adapt to changing business conditions, an improved risk analysis technique provides improved risk value calculation accuracy, improved ability to tailor the risk calculation to specific clients, and the ability to adjust the calculation method to account for rapid changes in fraud methodology and fraud trends. An illustrative technique of identifying risky transactions from a set of transactions involves obtaining a value of one or more parameters of a set of parameters from the client. Each parameter relates to an attribute of at least one of the set of transactions, such as a time of day of the transaction, the age of the account used, and a geographical location of the transaction. A risk processor obtains coefficients of common parameters from a memory location for use in a risk calculation based upon the client supplied values, for example, the geographical location of the transaction. The coefficients of parameters may be equations or describing the effect of a range of transaction values on the parameters associated with the risk calculation.

An illustrative system for identifying risky transactions from a set of transactions may include a computer with a logic circuit, a risk processor, a memory circuit, and a communications circuit for receiving the transactions and sending risk values to the clients. Each individual transaction may include values related to the individual transaction of an existing set of parameters indicating attributes of the set of transactions related to the risk of fraud. The memory circuit is used to store predetermined coefficients of at least some individual parameters of the set of parameters, for example mathematical coefficients for operands of the parameters for evaluation of the risk associated with the transaction values sent by the client.

The risk processor compares the values sent by the client related to the current transaction to the stored predetermined values of the parameter. In the case of a new parameter sent from the client, the logic circuit translates the new parameter into a set of statistical relationships between the new parameter and a known incidence of fraud, and the risk processor generates a likelihood of risk based on the common parameters, any new parameter, and statistical relationships of the set of statistical relationships, and transmits the risk value to the client.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a block diagram of a system for evaluating transaction risk.

FIG. 2 is flow chart for a method of evaluating transaction risk.

### DETAILED DESCRIPTION

Improved risk analysis methods address the prior art problems of poor risk value calculation accuracy, inability to tailor the risk calculation to specific clients, and the inability to adjust the calculation method to account for rapid changes in fraud methodology. Improved methods allow individual clients to use their knowledge of which risk parameters are most important to their particular business, and automatically translate a statement of a new parameter sent by the client to the risk analysis calculation engine into the type of statistical relationships used to evaluate risk using standard parameters.

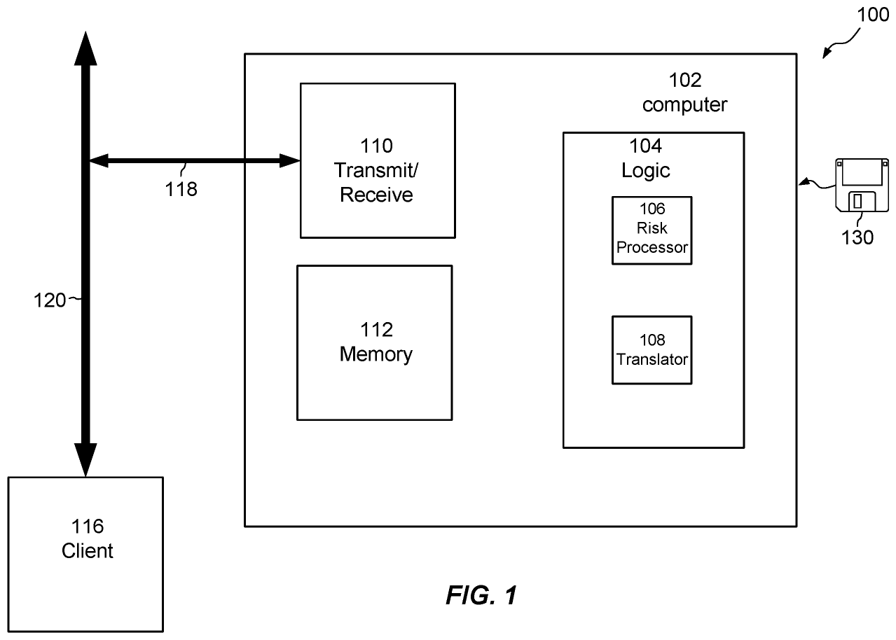

FIG. 1 is a block diagram of a system 100 for evaluating transaction risk having a computer 102 connected to a client user 116 via some communications means 120, for example, the internet, a network, an intranet, wired communications lines, wireless communications means such as cellular telephones or other communications means. The system 100 connects to the communications means 120 via bus 118, or other communications means such as wired or wireless communications.

The client user 116 may typically send information regarding a pending transaction request, for example, a credit card purchase, to the computer 102 for a risk analysis. The information sent by user 116 may include information such as the age of the credit card being used in the transaction, the time of day of the transaction, the geographical location of the transaction, or other data related to potential transaction risk factors or parameters. The computer 102 includes logic circuits 104, including a risk processor circuit 106 and a translation circuit 108 for translating client supplied fraud patterns into mathematical parameter equations and coefficient equations. As an example, it may be known that ATM withdrawals may have a statistical tendency to be fraudulent at certain specific times of day. Thus, a risk parameter of time of day may be useful in determining the likelihood of fraud, and the risk processor 106 may examine the transaction sent by the client 116 to see if the time of day is an included value. The relationship of the time of day to the risk of fraud may, for example, be a simple linear increase from a first value at noon to a higher second value at midnight, and thus the coefficient of the time of day parameter could be a linear equation having a slope value and one or more constant values. The relationship of risk of fraud to the time of day may have any shape and may not be a simple equation, whether linear, quadratic or other mathematical function, and could include statistical relationships and other sets of data.

The transaction information from client 116 is received by a Transmitter/Receiver 110 and sent to the computer 102 by internal communications means of any type. The logic circuit 104 checks the information from client 116 to determine if the risk parameter information includes only common parameters already stored in a memory location 112, and sends the information to the risk processor 106.

If the information from client 116 includes a new parameter, or a new constant or change to the coefficient of any parameter, then the logic 104 sends the new parameter to the translator circuit 108 for conversion into the proper format for use in the risk processor 106. The translator circuit sends the translated new parameter to the logic circuit 104, which stores the new parameter in the memory 112. The logic circuit then sends the information to the risk processor 106 for the risk calculation.

The risk processor 106 performs the risk calculation using the common parameters and the new parameter and obtains a risk score value. The risk score value may be stored in memory 112 and sent via transmitter/receiver 110 and communication means 118 and 120, to the client 116, for a decision on allowing the proposed transaction to be completed. Client 116 may typically have a risk analyst who receives at least some of the calculated risk score values and may keep track of the accuracy of the risk score values. The analyst may determine a new risk parameter and coefficient that may be useful for the client 116 specific business model, and may send the new parameter and coefficient to the computer 102 for use in the risk processor 106 calculation for transactions coming from client 116. In this fashion the risk calculation parameters and coefficients may be rapidly updated automatically and customized for specific client requirements to improve the risk calculation accuracy.

The computer 102 may be a general purpose computer or a special designed risk processor analytics engine. A computer program product 130 having a non-transitory, computer-readable storage medium which stores computer code may be used to program any or all of the computer 102, the logic 104, the risk processor and the translator 108 to calculate risk score values.

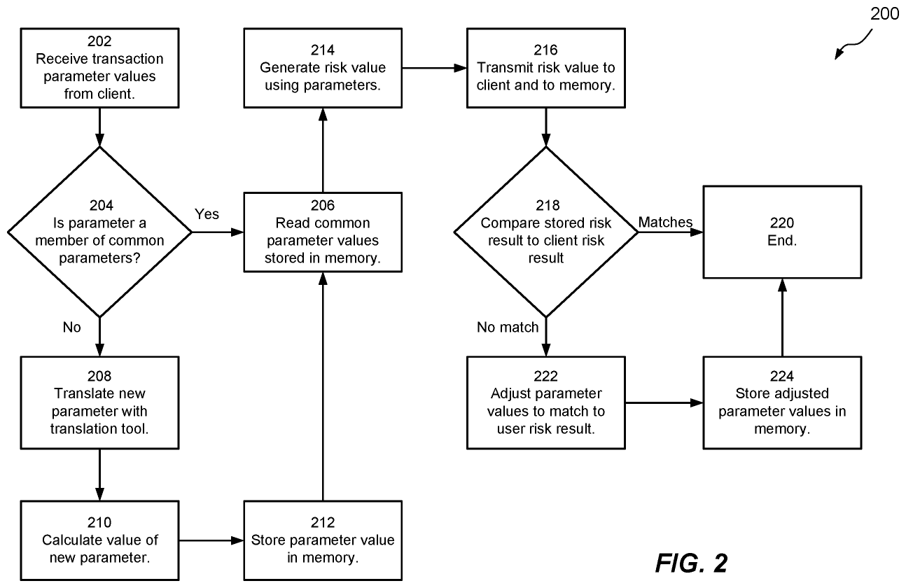

FIG. 2 is flow chart 200 for a method of evaluating transaction risk. At step 202 the method receives at the receiver 110 transaction values from the client 116. At step 204 the method determines if each parameter is a member of the common parameter set stored in the memory 112. If the parameter is found to be a common parameter and stored in the memory 112, the process moves to step 206 and obtains the stored values. If the parameter is not found to be a common parameter the method moves to step 208, where the new parameter is translated into proper form for calculating risk score values in translator 108.

At step 210 the method takes the new parameter and evaluates a coefficient for the parameter based upon either calculating risk scores values and comparing the calculated values against known fraud percentages or other methods known in the art such as Bayesian Predictors and statistical inference. The evaluation may occur anywhere in the computer 102, for example in risk processor 106 or translator 108.

At step 212 the method stored the new parameter and coefficient in the memory 112, where the new parameter may now be considered a common parameter, or it may be used only with the specific client's risk calculations. The method then converges with the common parameters at step 206.

At step 214 the method for both new and common parameters generates a risk score value at risk processor 106, using one or more of the transaction values obtained from the client 116.

At step 216 the method transmits the calculated risk score value to the client 116 via the transmitter 110, and to the memory 112. The method then moves to step 218 where the method compares the stored risk scores to actual client risk results in the logic 104. If the calculated risk score, or the average of recent past calculated risk scores match what the client or clients see as actual results, then the method moves to step 220 and end.

If the stored risk score value does not match the client values, then the method moves to step 222 where the logic 104 calculates adjusted parameter coefficient values to match the calculated risk score value to the actual risk result. The method moves to step 224 and stores the adjusted parameter coefficients in the memory 112, which may be used for all clients, or only for the specific client 116. The method then moves to step 220 and ends.

The improved method allows common parameters, for example, the geographical location, time of day, day of the week, account age, payment amount, frequency of transactions, and payment to a new payee for the transaction originator, to be used to calculated risk score values for a group of clients, and also allows individual clients to customize the calculation method to better reflect their own special requirements by providing a real time method of adding specialized parameters using the include translator device, or adjusting the coefficients of the common parameters.

While various embodiments of the invention have been particularly shown and described, it will be understood by those skilled in the art that various changes in form and details may be made therein without departing from the spirit and scope of the invention as defined by the appended claims.

What is claimed is:

1. An apparatus for updating a predictive analytics model in real time based on input from a client, the apparatus comprising:
a communications interface configured to receive client input that specifies a change in the predictive analytics model, the predictive analytics model including a plurality of common parameters each associated with a respective attribute;
a translation tool configured to transform at least a portion of the client input into a set of new parameters, each of the set of new parameters associated with a respective new attribute, and to update the predictive analytics model to include both the plurality of common parameters and the set of new parameters; and
a risk analytics engine configured to predict transaction risks based at least in part on the updated predictive analytics model.

2. The apparatus of claim 1, wherein the translation tool is further configured to translate each of the set of new parameters into a respective set of statistical relationships between the new parameter and known incidences of fraud.

3. The apparatus of claim 2, wherein at least one set of statistical relationships is represented as a line having a slope and an intercept.

4. The apparatus of claim 2, wherein at least one set of statistical relationships is represented as a quadratic function.

5. The apparatus of claim 2, wherein the communications interface is further configured to receive new parameter coefficients in the client input, each new parameter coefficient indicating a respective contribution of a respective parameter to predicted transaction risks.

6. The apparatus of claim 2, further comprising a memory configured to store each respective set of statistical relationships.

7. The apparatus of claim 2, wherein the client input includes at least one common parameter from the plurality of common parameters and at least one new parameter, and wherein the translator tool is further configured to update the predictive analytics model to include each new parameter.

8. The apparatus of claim 2, wherein the apparatus is configured to serve multiple clients, and wherein the client input is received from one of the multiple clients.

9. The apparatus of claim 8, further comprising a memory configured to store respective parameters and coefficients for each of the multiple clients.

10. A method of updating a predictive analytics model in real time based on input from a client, the method comprising:
receiving client input that specifies a change in the predictive analytics model, the predictive analytics model including a plurality of common parameters each associated with a respective attribute;
transforming at least a portion of the client input into a set of new parameters, each of the set of new parameters associated with a respective new attribute;
updating the predictive analytics model to include both the plurality of common parameters and the set of new parameters; and
predicting, using a risk analytics engine, a transaction risk based at least in part on the updated predictive analytics model.

11. The method of claim 10, further comprising translating each of the set of new parameters into a respective set of statistical relationships between the new parameter and known incidences of fraud.

12. The method of claim 11, wherein receiving the client input includes receiving a set of new parameter coefficients, each of the set of new parameter coefficients indicating a respective contribution of a respective parameter to the predicted transaction risk.

13. The method of claim 11, wherein the client input includes at least one common parameter from the plurality of common parameters and at least one new parameter, and wherein updating the predictive analytics model includes providing each new parameter as part of the predictive analytics model.

14. The method of claim 11, further comprising:
serving multiple clients, the client input being received from one of the multiple clients; and
storing, in a memory, respective parameters and coefficients for each of the multiple clients.

15. A computer program product including a set of non-transitory, computer-readable media having instructions which, when executed by control circuitry of a computerized apparatus, cause the computerized apparatus to perform a method of updating a predictive analytics model in real time based on input from a client, the method comprising:
receiving client input that specifies a change in the predictive analytics model, the predictive analytics model including a plurality of common parameters each associated with a respective attribute;
transforming at least a portion of the client input into a set of new parameters, each of the set of new parameters associated with a respective new attribute;
updating the predictive analytics model to include both the plurality of common parameters and the set of new parameters; and
predicting, using a risk analytics engine, a transaction risk based at least in part on the updated predictive analytics model.

16. The computer program product of claim 15, wherein the method further comprises translating each of the set of new parameters into a respective set of statistical relationships between the new parameter and known incidences of fraud.

17. The computer program product of claim 16, wherein translating each of the set of new parameters into a respective set of statistical relationships includes representing at least one of the statistical relationships as one of (i) a line having a slope and an intercept and (ii) a quadratic function.

18. The computer program product of claim 15, wherein receiving the client input includes receiving a set of new parameter coefficients, each of the set of new parameter coefficients indicating a respective contribution of a respective parameter to the predicted transaction risk.

19. The computer program product of claim 15, wherein the client input includes at least one common parameter from the plurality of common parameters and at least one new parameter, and wherein updating the predictive analytics model includes providing each new parameter as part of the predictive analytics model.

20. The computer program product of claim 15, wherein the method further comprises:
serving multiple clients, the client input being received from one of the multiple clients; and
storing, in a memory, respective parameters and coefficients for each of the multiple clients.
